(19) United States
(12) Patent Application Publication
(10) Pub. No.: US 2003/0041156 A1
(43) Pub. Date: Feb. 27, 2003

(54) Method, system, and product for embedding demographic information in network packets

(75) Inventors: Clifford A. Pickover, Yorktown Heights, NY (US); William Grey, Millwood, NY (US); Paul Andrew Moskowitz, Yorktown Heights, NY (US); Stephen J. Boies, Mahopac, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/934,366

(22) Filed: Aug. 21, 2001

(51) Int. Cl. G06F 15/16; G06F 17/60

(52) U.S. Cl. 709/230; 709/246; 709/250; 705/14

(57) ABSTRACT

A computer system, method, and product are disclosed for embedding demographic information in network packets. The computer system includes a server computer system coupled to a client computer system using a network. Demographic information is obtained about a user of the client computer system. This demographic information is embedded into network packets transmitted by the client computer system to the server computer system.

### BACKGROUND OF THE INVENTION

1. Technical Field

The present invention relates generally to an improved data processing system, and more particularly to a method, system, and product for embedding demographic information in network packets.

2. Description of Related Art

The Internet, also referred to as an “internetwork”, is a set of computer networks, possibly dissimilar, joined together by means of gateways that handle data transfer and the conversion of messages from the sending network to the protocols used by the receiving network, with Internet Protocol packets used as needed. When capitalized, the term “Internet” refers to the collection of networks and gateways that use the TCP/IP suite of protocols. The Internet has become a cultural fixture as a source of both information and entertainment. Many businesses are creating Internet sites as an integral part of their marketing efforts, informing consumers of the products or services offered by the businesses or providing other information seeking to engender brand loyalty. Many federal, state, and local government agencies are also employing Internet sites for informational purposes. The agencies include the Internal Revenue Service and secretaries of state, which must interact with virtually all segments of society. Providing informational guides and/or searchable databases of online public records may reduce operating costs.

The Internet is becoming increasingly popular as a medium for commercial transactions. With respect to commerce on the Web, individual consumers and business use the Web to purchase various goods and services. Some companies offer goods and services solely on the Web while others use the Web to extend their reach.

Businesses often use demographic information collected about their customers to tailor advertising, pricing, and promotions made available to these customers. Collecting this information may be difficult to accomplish. Surveys have been used to collect such information. For example, when a customer purchases a product, a warranty card is often included which may be completed by the customer and returned to the seller. These cards often ask questions about a customer's age, gender, and income, as well as asking for other information. Demographic information has also been collected using telephone or in-person surveys. These surveys rely on the respondent to honestly and accurately answer questions regarding their demographic status.

The current methods for returning demographic information to a business are often voluntary. Customers do not have to return the warranty cards. Further, customers and potential customers may be reluctant to participate in a telephone or in-person interview. Further, because the amount of business conducted that utilizes the Internet continues to increase, a large number of customers are being overlooked.

Therefore, it would be advantageous to have an improved method, system, and product for embedding demographic information into network packets transmitted by a client to a server.

### SUMMARY OF THE INVENTION

A computer system, method, and product are disclosed for embedding demographic information in network packets. The computer system includes a server computer system coupled to a client computer system using a network. Demographic information is obtained about a user of the client computer system. This demographic information is embedded into network packets transmitted by the client computer system to the server computer system. The demographic information is automatically embedded by the client computer system without user intervention.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a distributed data processing system in which the present invention may be implemented;

FIG. 2 is a block diagram of a data processing system that may be implemented as a server in accordance with a preferred embodiment of the present invention;

FIG. 3 is a block diagram of a data processing system that may be implemented as a client in accordance with the present invention;

FIG. 4 is a block diagram of an Internet Protocol (IP) packet including a header and a data portion in accordance with the present invention;

FIG. 5 is a high level flow chart which illustrates the generation and transmission of a network packet which includes demographic information according to the present invention;

FIG. 6 is a high level flow chart which depicts retrieving demographic information from received network packets according to the present invention; and

FIG. 7 is a high level flow chart which illustrates utilizing demographic information retrieved from a network packet according to the present invention.

### DETAILED DESCRIPTION OF THE PREFERRED EMBODIMENT

The invention is preferably realized using a well-known computing platform, such as an IBM RS/6000 workstation running the IBM AIX operating system. However, it may be realized in other popular computer system platforms, such as an IBM personal computer running the Microsoft Windows operating system or a Sun Microsystems workstation running operating systems such as UNIX or LINUX, without departing from the spirit and scope of the invention.

The present invention is a method, system, and product for embedding demographic information into network packets transmitted from a client computer system to a server computer system. The demographic information is obtained about a user of the client. The demographic information is then inserted into network packets transmitted by the client. The information may then be extracted from the network packets by the server and used to tailor advertising, promotions, pricing, and other information to particular users or types of users.

The demographic information is embedded automatically by a client computer system without any user intervention. This information may be inserted into each network packet, or it may be embedded in only selected or designated network packets. For example, the demographic information may be embedded in a header packet or a footer packet.

The demographic information may be embedded into either the data portion or the header portion of a network packet, such as into the IP header or IP data portion. One method for embedding the information in the data portion is to first store (insert) a beginning tag into the data portion of the packet followed by each data item which makes up the demographic information. Each data item is delineated by delimiters. Then, an ending tag is stored after the last data item. The server may then extract the demographic information by searching for the beginning tag and extracting data items until an ending tag is reached.

The demographic information may be collected by a user's client computer system, the Internet Service Provider used by a client, a network server, an Internet Web site, a router, an individual computer user, or by using any other suitable method or system. The demographic information may be encrypted prior to embedding it in the network packet. The demographic information may be used to select and forward information such as e-mail to users.

With reference now to the figures, FIG. 1 depicts a pictorial representation of a distributed data processing system in which the present invention may be implemented. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections. The communications network 102 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 104 without departing from the scope of the present invention. Moreover, as used herein, communications include those enabled by wired or wireless technology.

In the depicted example, a server 104 is connected to network 102 along with storage unit 106. In addition, clients 108, 110, and 112 also are connected to network 102. These clients 108, 110, and 112 may be, for example, personal computers, portable computers, mobile or fixed user stations, workstations, network terminals or servers, cellular telephones, kiosks, dumb terminals, personal digital assistants, two-way pagers, smart phones, information appliances, or network computers. For purposes of this application, a network computer is any computer, coupled to a network, which receives a program or other application from another computer coupled to the network. In the depicted example, server 104 provides data, such as boot files, operating system images, and applications to clients 108-112. Clients 108, 110, and 112 are clients to server 104.

Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, distributed data processing system 100 also may be implemented as a number of different types of networks, such as for example, an intranet, a local area network (LAN), or a wide area network (WAN). FIG. 1 is intended as an example, and not as an architectural limitation for the present invention.

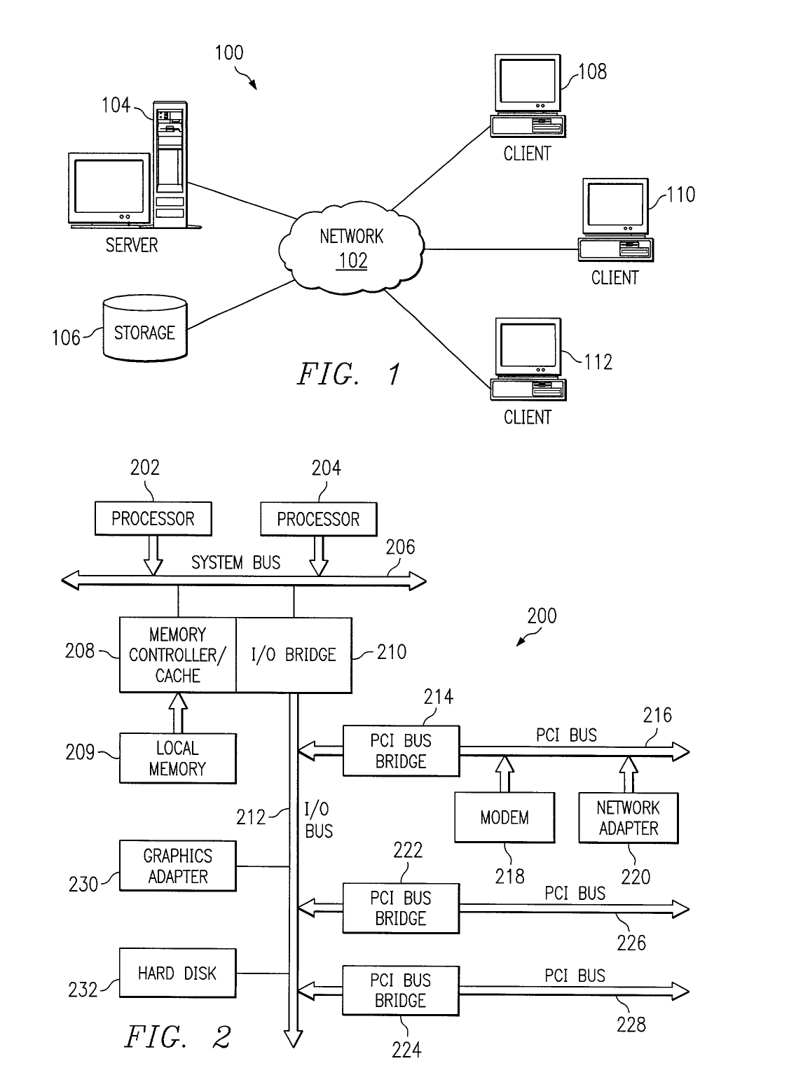

Referring to FIG. 2, a block diagram of a data processing system that may be implemented as a server, such as server 104 in FIG. 1, is depicted in accordance with a preferred embodiment of the present invention.

Server 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. 1/0 bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, server 200 allows connections to multiple network computers. A graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

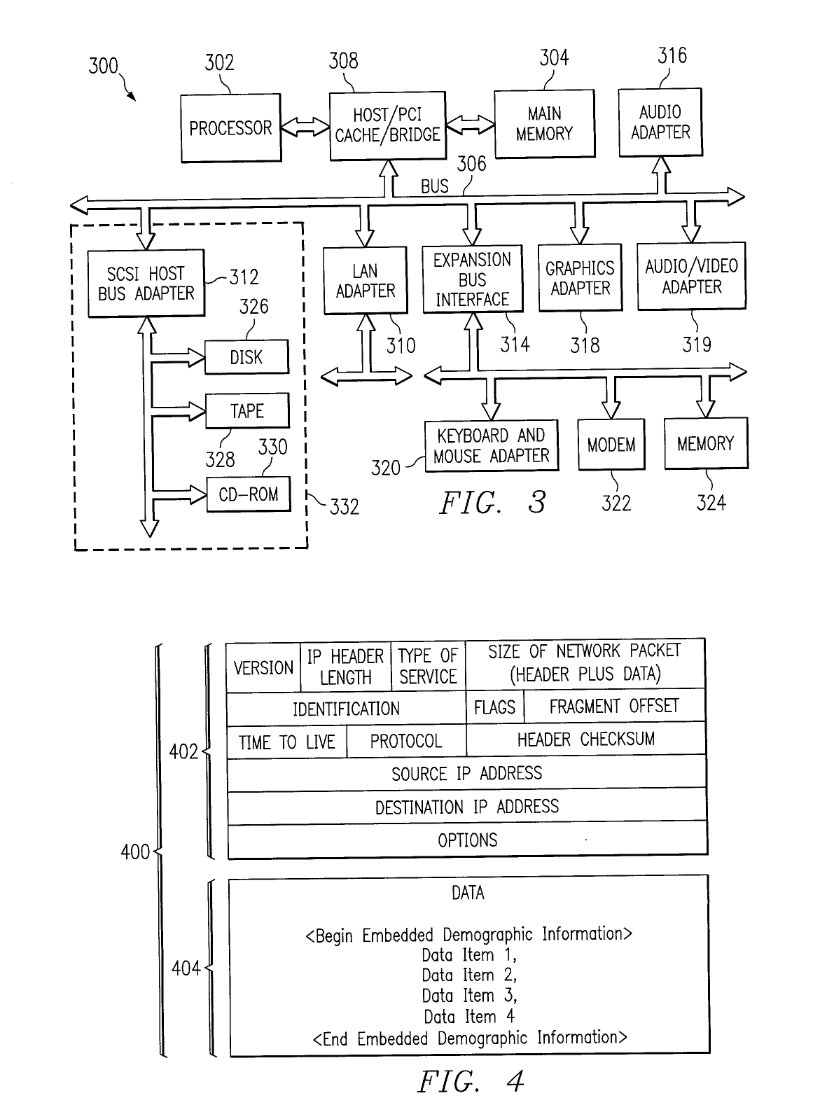

FIG. 3 illustrates a data processing system that may be implemented as a client in accordance with the present invention. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provides calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

Data processing system 300 may take various forms, such as a stand-alone computer or a networked computer. As a further example, data processing system 300 may be a personal digital assistant (PDA) device, which is configured with ROM and/or flash ROM in order to provide nonvolatile memory for storing operating system files and/or user-generated data. The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a block diagram of an Internet Protocol (IP) packet 400 including a header 402 and a data portion 404 in accordance with the present invention. The Internet Protocol defines the number, size, and type of fields that are included in the header 402. The present invention may be implemented by inserting the demographic information into header 402. This implementation may require the Internet Protocol standard to be changed such that a new field is defined for the demographic information, or the definition of an existing field may be changed to permit the insertion of demographic information into an existing field.

The present invention may also be implemented by inserting the demographic information into data portion 404. This implementation does not require any modification to the Internet Protocol standard. The information may be embedded anywhere in the existing data portion. The information may be embedded as a string identified by a beginning tag and an ending tag. The demographic information includes individual data items which are then each embedded between the tags and delineated by delimiters. For example, the string may include the following: <begin embedded demographic information>data item 1, data item 2, data item 3, data item 4<end embedded demographic information>. The data items are the individual demographic information. For example, a data item could be the gender, income, or age of a user.

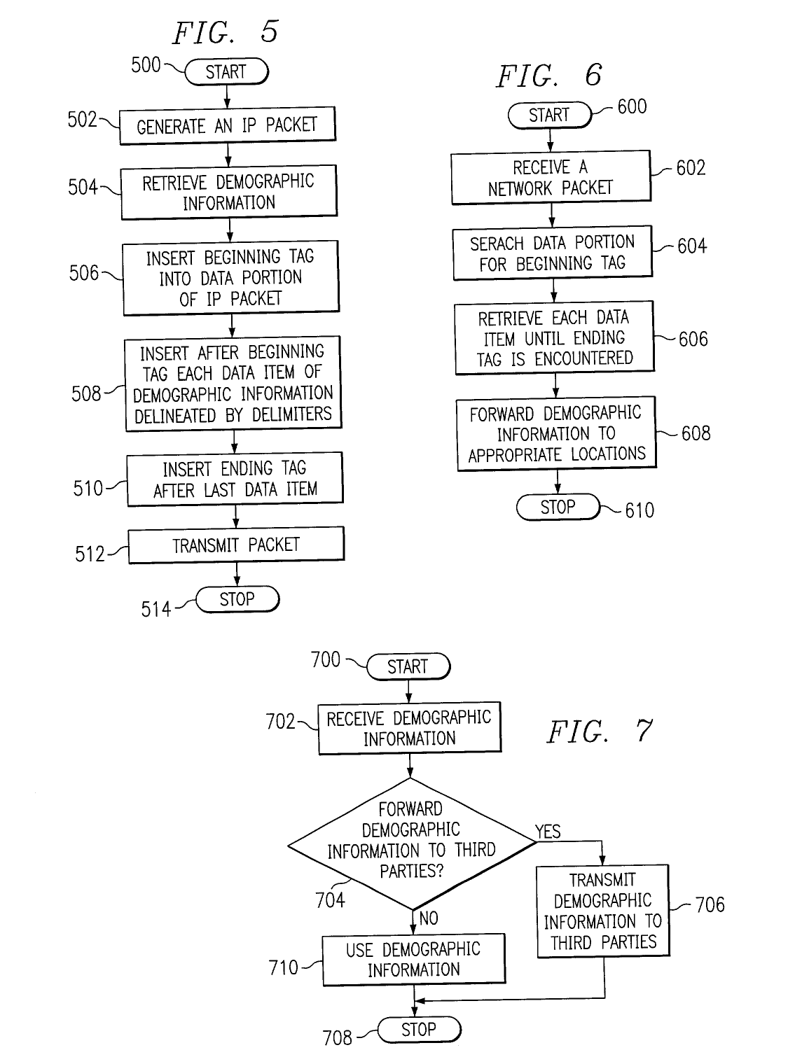

FIGS. 5-7 depict an embodiment of the present invention where the demographic information is embedded within the data portion of an IP packet. Alternatively, as described above, the present invention could be implemented by storing the demographic information in the header of the IP packet.

FIG. 5 is a high level flow chart which illustrates the generation and transmission of a network packet which includes demographic information according to the present invention. The process starts as depicted by block 500 and thereafter passes to block 502 which illustrates a generation of an IP packet which includes an IP header and an IP data portion. Next, block 504 depicts a retrieval of demographic information. The demographic information may be obtained using a variety of different methods. The demographic information may be obtained directly from a user. Alternatively, the information may be collected by a user's Internet service provider, a Web site, a router, any network server accessed by a user, the user's client computer system, or any other software or hardware device accessed by a user. The process then passes to block 506 which illustrates the insertion of a beginning tag into the data portion of the IP packet. The beginning tag may take one of many different forms. For example, the tag may be a particular symbol or combination of symbol and text. The beginning tag depicted by FIG. 4 is “<begin embedded demographic information>”. Thereafter, block 508 depicts the insertion after the beginning tag of each demographic data item. Each data item may be delineated by a delimiter.

The data items may include a user's name, address, phone number, age, zip code, income, gender, marital status, educational level, personal preferences, number of children, number of pets, number of household residents, identification numbers, information about the state of the sender's client computer system at the time the IP packet was transmitted, information about the state of the sender's client computer system at a time other than the time the packet was transmitted, information about previous Web site visits such as stored on the sender's computer system in cookies, credit information, purchasing history, information about assets or liabilities, code numbers for receiving special services, credit card numbers, micorpayment information, encryption information, passwords, numbers identifying product or offering promotions, information about permission marketing parameters, referral information, or any other type of demographic information.

Each data item may be delineated by a delimiter, such as a comma, slash, or space. Each data item will typically have a particular location within the string. For example, each string may conform to the following format: <beginning tag>address,age,income<ending tag>. When this format is followed, each packet will include a string which stores the address, if one is available, immediately after the beginning tag. One example string is: <begin embedded demographic information>1234 State Street,34,female<end embedded demographic information>. The client computer system automatically embeds demographic information and the necessary tags without any intervention from the user. Next, block 510 illustrates the insertion of an ending tag immediately after the last data item. The demographic information may be encrypted utilizing any suitable encryption scheme. Block 512, then, depicts the transmission of the packet. The process then terminates as illustrated by block 514.

FIG. 6 is a high level flow chart which depicts retrieving demographic information from received network packets according to the present invention. The process starts as depicted by block 600 and thereafter passes to block 602 which illustrates a receipt of a network packet which includes an IP packet. Next, block 604 depicts searching the data portion of the IP packet for the beginning tag. Thereafter, block 606 illustrates the retrieval of each data item from the string until the ending tag is encountered. Block 608, then, depicts the forwarding of the demographic information to the appropriate locations. The process then terminates as depicted by block 610.

FIG. 7 is a high level flow chart which illustrates utilizing demographic information retrieved from a network packet according to the present invention. The process starts as depicted by block 700 and thereafter passes to block 702 which illustrates a receipt of demographic information. Next, block 704 depicts a determination of whether or not this information should be forwarded to third parties. If a determination is made that the information should be forwarded to third parties, the process passes to block 706 which illustrates the transmission of the demographic information to the appropriate third parties. The process then terminates as depicted by block 708. Referring again to block 704, if a determination is made that the information is not to be forwarded to third parties, the process passes to block 710 which illustrates using the demographic information. The process then terminates as illustrated by block 708.

The demographic information may be used in many different ways. Advertising or promotions may be selected based on the demographics of all users of the system or a subset of users. The demographic information may be used to select and direct e-mail or other information. The type of products or pricing offered may be based on the demographic information collected from network packets.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a computer system including a server computer system coupled to a client computer system using a network, said method comprising the steps of:
obtaining demographic information about a user of said client computer system; and
automatically embedding, by said client computer system, said demographic information into network packets transmitted by said client computer system, wherein said demographic information is automatically embedded by said client computer system without user intervention.

2. The method according to claim 1, further comprising the step of embedding said demographic information into each network packet transmitted by said client computer system to said server computer system.

3. The method according to claim 1, further comprising the step of embedding said demographic information into Internet Protocol packets transmitted by said client computer system to said server computer system.

4. The method according to claim 3, further comprising the step of embedding said demographic information into a data portion of Internet Protocol packets transmitted by said client computer system to said server computer system.

5. The method according to claim 4, further comprising the steps of:
storing a beginning tag in said data portion;
storing said demographic information immediately after said beginning tag in said data portion; and
storing an ending tag immediately after said demographic information in said data portion.

6. The method according to claim 5, further comprising the steps of:
storing each data item included in said demographic information after said beginning tag; and
delineating each data item utilizing delimiters.

7. The method according to claim 3, further comprising the step of embedding said demographic information into a header portion of Internet Protocol packets transmitted by said client computer system to said server computer system.

8. The method according to claim 1, further comprising the steps of:
receiving a network packet;
searching said network packet for a beginning tag; and
retrieving data located after said beginning tag and before an ending tag as said demographic information.

9. The method according to claim 1, further comprising the steps of:
encrypting said demographic information; and
embedding said encrypted demographic information into network packets.

10. The method according to claim 1, further comprising the steps of:
receiving a network packet;
retrieving demographic information from said network packet; and
forwarding said demographic information to a third party.

11. The method according to claim 1, further comprising the steps of:
receiving a network packet by a server computer system;
retrieving demographic information from said network packet; and
utilizing said demographic information to determine demographics of users of said server computer system.

12. The method according to claim 1, further comprising the steps of:
receiving a network packet by a server computer system;
retrieving demographic information from said network packet; and
utilizing said demographic information to select advertising.

13. The method according to claim 1, further comprising the steps of:
receiving a network packet by a server computer system;
retrieving demographic information from said network packet; and
utilizing said demographic information to forward e-mail to users.

14. The method according to claim 1, further comprising the steps of:
receiving a network packet by a server computer system;
retrieving demographic information from said network packet; and
utilizing said demographic information to select promotions.

15. The method according to claim 1, further comprising the step of obtaining demographic information about a user of said client computer system from said client computer system.

16. The method according to claim 1, further comprising the step of obtaining demographic information about a user of said client computer system from an Internet Service Provider.

17. The method according to claim 1, further comprising the step of obtaining demographic information about a user of said client computer system from said server computer system.

18. The method according to claim 1, further comprising the step of obtaining demographic information about a user of said client computer system from an Internet site.

19. The method according to claim 1, further comprising the step of obtaining demographic information about a user of said client computer system from a router.

20. The method according to claim 1, further comprising the step of obtaining demographic information about a user of said client computer system from said user.

21. A method in a computer system including a server computer system coupled to a client computer system using a network, said method comprising the steps of:
receiving network packets by said server computer system; and
obtaining demographic information embedded in a header portion of said network packets.

22. A method in a computer system including a server computer system coupled to a client computer system using a network, said method comprising the steps of:
receiving network packets including demographic information embedded in a header portion of said network packets; and
forwarding said network packets.

23. A computer program product in a computer system including a server computer system coupled to a client computer system using a network, comprising:
instruction means for obtaining demographic information about a user of said client computer system; and
instructions means for automatically embedding, by said client computer system, said demographic information into network packets transmitted by said client computer system, wherein said demographic information is automatically embedded by said client computer system without user intervention.

24. The product according to claim 23, further comprising instruction means for embedding said demographic information into each network packet transmitted by said client computer system to said server computer system.

25. The product according to claim 23, further comprising instruction means for embedding said demographic information into Internet Protocol packets transmitted by said client computer system to said server computer system.

26. The product according to claim 25, further comprising instruction means for embedding said demographic information into a data portion of Internet Protocol packets transmitted by said client computer system to said server computer system.

27. The product according to claim 26, further comprising:
instruction means for storing a beginning tag in said data portion;
instruction means for storing said demographic information immediately after said beginning tag in said data portion; and
instruction means for storing an ending tag immediately after said demographic information in said data portion.

28. The product according to claim 27, further comprising:
instruction means for storing each data item included in said demographic information after said beginning tag; and
instruction means for delineating each data item utilizing delimiters.

29. The product according to claim 25, further comprising instruction means for embedding said demographic information into a header portion of Internet Protocol packets transmitted by said client computer system to said server computer system.

30. The product according to claim 23, further comprising:
instruction means for receiving a network packet;
instruction means for searching said network packet for a beginning tag; and
instruction means for retrieving data located after said beginning tag and before an ending tag as said demographic information.

31. The product according to claim 23, further comprising:
instruction means for encrypting said demographic information; and
instruction means for embedding said encrypted demographic information into network packets.

32. The product according to claim 23, further comprising:
instruction means for receiving a network packet;
instruction means for retrieving demographic information from said network packet; and
instruction means for forwarding said demographic information to a third party.

33. The product according to claim 23, further comprising:
instruction means for receiving a network packet by a server computer system;
instruction means for retrieving demographic information from said network packet; and
instruction means for utilizing said demographic information to determine demographics of users of said server computer system.

34. The product according to claim 23, further comprising:
instruction means for receiving a network packet by a server computer system;
instruction means for retrieving demographic information from said network packet; and
instruction means for utilizing said demographic information to select advertising.

35. The product according to claim 23, further comprising:
instruction means for receiving a network packet by a server computer system;
instruction means for retrieving demographic information from said network packet; and
instruction means for utilizing said demographic information to forward e-mail to users.

36. The product according to claim 23, further comprising:
instruction means for receiving a network packet by a server computer system;
instruction means for retrieving demographic information from said network packet; and
instruction means for utilizing said demographic information to select promotions.

37. The product according to claim 23, further comprising instruction means for obtaining demographic information about a user of said client computer system from said client computer system.

38. The product according to claim 23, further comprising instruction means for obtaining demographic information about a user of said client computer system from an Internet Service Provider.

39. The product according to claim 23, further comprising instruction means for obtaining demographic information about a user of said client computer system from said server computer system.

40. The product according to claim 23, further comprising instruction means for obtaining demographic information about a user of said client computer system from an Internet site.

41. The product according to claim 23, further comprising instruction means for obtaining demographic information about a user of said client computer system from a router.

42. The product according to claim 23, further comprising instruction means for obtaining demographic information about a user of said client computer system from said user.

43. A computer system including a server computer system coupled to a client computer system using a network, comprising:
means for obtaining demographic information about a user of said client computer system; and
said client computer system for automatically embedding said demographic information into network packets transmitted by said client computer system, wherein said demographic information is automatically embedded by said client computer system without user intervention.

44. The system according to claim 43, further comprising said client computer system for embedding said demographic information into each network packet transmitted by said client computer system to said server computer system.

45. The system according to claim 43, further comprising said client computer system for embedding said demographic information into Internet Protocol packets transmitted by said client computer system to said server computer system.

46. The system according to claim 45, further comprising said client computer system for embedding said demographic information into a data portion of Internet Protocol packets transmitted by said client computer system to said server computer system.

47. The system according to claim 46, further comprising:
a beginning tag being stored in said data portion;
said demographic information being stored immediately after said beginning tag in said data portion; and
an ending tag being stored immediately after said demographic information in said data portion.

48. The system according to claim 47, further comprising:
each data item being stored included in said demographic information after said beginning tag; and
each data item being delineated utilizing delimiters.

49. The system according to claim 45, further comprising said client computer system for embedding said demographic information into a header portion of Internet Protocol packets transmitted by said client computer system to said server computer system.

50. The system according to claim 43, further comprising:
said server computer system for receiving a network packet;
said server computer system for searching said network packet for a beginning tag; and
said server computer system for retrieving data located after said beginning tag and before an ending tag as said demographic information.

51. The system according to claim 43, further comprising:
said client computer system for encrypting said demographic information; and
said client computer system for embedding said encrypted demographic information into network packets.

52. The system according to claim 43, further comprising:
said server computer system for receiving a network packet;
said server computer system for retrieving demographic information from said network packet; and
said server computer system for forwarding said demographic information to a third party.

53. The system according to claim 43, further comprising:
said server computer system for receiving a network packet by a server computer system;
said server computer system for retrieving demographic information from said network packet; and
said server computer system for utilizing said demographic information to determine demographics of users of said server computer system.

54. The system according to claim 43, further comprising:
said server computer system for receiving a network packet by a server computer system;
said server computer system for retrieving demographic information from said network packet; and
said server computer system for utilizing said demographic information to select advertising.

55. The system according to claim 43, further comprising:
said server computer system for receiving a network packet by a server computer system;
said server computer system for retrieving demographic information from said network packet; and
said server computer system for utilizing said demographic information to forward e-mail to users.

56. The system according to claim 43, further comprising:
said server computer system for receiving a network packet by a server computer system;
said server computer system for retrieving demographic information from said network packet; and
said server computer system for utilizing said demographic information to select promotions.

57. The system according to claim 43, further comprising said client computer system for obtaining demographic information about a user of said client computer system.

58. The system according to claim 43, further comprising said client computer system for obtaining demographic information about a user of said client computer system from an Internet Service Provider.

59. The system according to claim 43, further comprising said client computer system for obtaining demographic information about a user of said client computer system from said server computer system.

60. The system according to claim 43, further comprising said client computer system for obtaining demographic information about a user of said client computer system from an Internet site.

61. The system according to claim 43, further comprising said client computer system for obtaining demographic information about a user of said client computer system from a router.

62. The system according to claim 43, further comprising said client computer system for obtaining demographic information about a user of said client computer system from said user.
